(19) United States
(12) Patent Application Publication
(10) Pub. No.: US 2012/0251877 A1
(43) Pub. Date: Oct. 4, 2012

(54) SECONDARY LITHIUM ION BATTERY

(75) Inventors: Kai WU, Dongguan city (CN); Yao ZHANG, Dongguan city (CN); Wan-hao YAO, Dongguan city (CN)

(73) Assignees: Dongguan Amperex Electronics Technology Limited, Dongguan city (CN); Dongguan Amperex Technology Limited, Dongguan city (CN)

(21) Appl. No.: 13/432,925

(22) Filed: Mar. 28, 2012

(30) Foreign Application Priority Data
Mar. 31, 2011 (CN) 201110079452.X

(51) Int. Cl. H01M 4/64

(52) U.S. Cl. 429/211

(57) ABSTRACT

A secondary lithium ion battery includes an anode electrode having an anode current collector and an anode active material formed on the anode current collector, a cathode electrode having a cathode current collector and a cathode active material formed on the cathode current collector; a separator interposed between the anode electrode and the cathode electrode, and a nonaqueous liquid electrolyte. The anode active material contains lithium titanate and amorphous carbon. The hybrid anode electrode containing lithium titanate and amorphous carbon of the secondary lithium ion battery according to the present invention can reduce swelling of the secondary lithium ion battery during storage or cycle and prolong life span of the secondary lithium ion battery.

### CROSS-REFERENCE TO RELATED APPLICATION

The present patent invention claims priority to Chinese Patent Application No. CN 201110079452.X filed on Mar. 31, 2011, which is incorporated by reference herein in its entirety.

### FIELD OF THE INVENTION

The present invention generally relates to secondary lithium ion batteries, and more particularly, relates to a secondary lithium ion battery which uses lithium titanate (Li₄Ti₅O₁₂) as anode active material.

### BACKGROUND OF THE INVENTION

At present, anode active material lithium titanate (Li₄Ti₅O₁₂) is widely used in secondary lithium ion batteries due to desirable safety performance and electrochemical performance.

For conventional secondary lithium ion battery which uses lithium titanate as anode active material, there is only one anode active material, i.e. lithium titanate, in the anode electrode. Other materials contained in the anode electrode, such as carbon black, vapor grown carbon fiber (VGCF) or graphite introduced during either lithium titanate synthesis or battery electrode manufacturing, is only used as conductive agent to improve electronic conductivity of the electrode. After being stored or circled for certain numbers, gas may be generated in secondary lithium ion batteries, especially at high temperature, which will reduce life span of the secondary lithium ion battery.

What is needed, therefore, is to provide a secondary lithium ion battery which has desirable lift span.

### SUMMARY OF THE INVENTION

One objective of the present invention is to provide a secondary lithium ion battery which has desirable life span.

According to one embodiment of the present invention, a secondary lithium ion battery includes an anode electrode having anode current collector and anode active material formed on the anode current collector, a cathode electrode having a cathode current collector and a cathode active material formed on the cathode current collector, a separator interposed between the anode electrode and the cathode electrode, and a nonaqueous liquid electrolyte, wherein the anode active material contains lithium titanate and amorphous carbon.

Preferably, the anode active material contains lithium titanate and hard carbon, or contains lithium titanate and soft carbon, or contains lithium titanate, hard carbon and soft carbon.

Preferably, the amorphous carbon has a shape of needle, tube flake, sphere or fiber.

Preferably, the amorphous carbon has a size ranging from several nanometers to dozens of micrometers.

Preferably, the amorphous carbon has a size ranging from several hundreds of nanometers to several micrometers.

Preferably, weight ratio of the lithium titanate to the amorphous carbon ranges from 98:2 to 50:50.

Preferably, the amorphous carbon has d₀₀₂ spacing larger than 0.34 nm.

Preferably, the anode electrode contains binder and carbonaceous conductive agent.

Preferably, the carbonaceous conductive agent is selected from a group consisting of carbon black, vapor grown carbon fiber and graphite.

The hybrid anode electrode containing lithium titanate and amorphous carbon of the secondary lithium ion battery in accordance with the present invention can reduce swelling of the secondary lithium ion battery during storage or cycling and, thus, prolong life span of the secondary lithium ion battery, especially at high temperature. Additionally, the amorphous carbon in the hybrid anode active material can remarkably improve the electronic conductivity of the electrode and further improve the power density of the secondary lithium ion battery.

Other advantages and novel features will be drawn from the following detailed description of preferred embodiment with the attached drawings, in which:

### BRIEF DESCRIPTION OF THE DRAWINGS

FIG. 1 depicts an illustrative cross-sectional view of a battery cell for use in a secondary lithium ion battery according to one embodiment of the present invention;

FIG. 2 is a graph showing first charge curves of coin cells at 25° C. and at the rate of 0.05 C, using Li₄Ti₅O₁₂, hard carbon, soft carbon, Li₄Ti₅O₁₂/hard carbon, Li₄Ti₅O₁₂/soft carbon as anode active material and using lithium metal as counter electrode, wherein weight ratio of Li₄Ti₅O₁₂ to hard carbon is 75:15, weight ratio of Li₄Ti₅O₁₂ to soft carbon is 75:15;

FIG. 3 is a graph showing electronic conductivity of the anode electrodes of Comparative Example, Example 1 and Example 2;

FIG. 4 is a graph showing change in thickness of the secondary lithium ion batteries of Comparative Example and Example 1 after fully charged and stored at 85° C. for 4 hours; and

FIG. 5 is a graph showing cyclic performance curves of the secondary lithium ion batteries of Comparative Example and Example 1 at 45° C. at the rate of 10 C/10 C.

### DETAILED DESCRIPTION OF THE INVENTION

According to one embodiment of the present invention, a secondary lithium ion battery includes an anode electrode 10 including an anode current collector 102 and anode active material 104 formed on the anode current collector 102, a cathode electrode 20 including cathode current collector 202 and cathode active material 204 formed on the cathode current collector 202, a separator 30 between the anode electrode 10 and the cathode electrode 20, and a nonaqueous liquid electrolyte. The anode active material 104 contains Li₄Ti₅O₁₂ and amorphous carbon. The anode electrode 10 contains binder and carbonaceous conductive agent and the carbonaceous conductive agent is selected from a group consisting of carbon black, vapor grown carbon fiber (VGCF) and graphite.

Preferably, the amorphous carbon has d₀₀₂ spacing larger than 0.34 nm and can be or cannot be graphitized at a high temperature of 2500° C.˜3000° C.

Preferably, the amorphous carbon further contains soft carbon and/or hard carbon. Soft carbon refers to amorphous carbon that can be graphitized at a temperature higher than 2500° C. Hard carbon is pyrolytic carbon of polymer. Hard carbon can hardly be graphitized even at a temperature higher than 2500° C.

Preferably, the amorphous carbon may have different shapes, including but not limited to needle, tube flake, sphere or fiber.

Preferably, the amorphous carbon has a size ranging from several nanometers to dozens of micrometers, and more preferably, ranging from hundreds of nanometers to several micrometers,

Preferably, weight ratio of Li₄Ti₅O₁₂ to amorphous carbon ranges from 98:2 to 50:50.

### EXAMPLES

### Comparative Example

(Manufacture of Anode Electrode)

To N-methyl-2-pyrrolidone (NMP) as a solvent, 90 wt % of Li₄Ti₅O₁₂ as anode active material, 5 wt % of polyvinylidene fluoride (PVDF) as binder, 5 wt % of carbon black as conductive agent were added to form slurry for an anode electrode. The anode slurry was evenly coated on Cu foil as anode current collector and dried to form an anode electrode. Then, the anode electrode was subjected to roll process.

(Manufacture of Cathode Electrode)

To NMP as a solvent, 90 wt % of LiNi_{1/3}Co_{1/3}Mn_{1/3}O₂ as cathode active material, 5 wt % of PVDF as binder and 5 wt % of carbon black as conductive agent were added to form slurry for a cathode electrode. The cathode slurry was evenly coated on Al foil as cathode current collector and dried to form a cathode electrode. The cathode electrode then was subjected to roll process.

(Manufacture of Secondary Lithium Ion Battery)

The anode electrode and the cathode electrode obtained as described above were stacked with separator of microporous membrane of polypropylene (PP) interposed therebetween to form an assembly. Then, an electrolyte (propylene carbonate (PC)/ethylene carbonate (EC)/dimethyl carbonate (DMC)=1:1:1 (weight ratio) containing 1M of lithium hexafluorophosphate (LiPF₆)) was injected thereto to provide a secondary lithium ion battery.

### Example 1

(Manufacture of Anode Electrode)

To N-methyl-2-pyrrolidone (NMP) as a solvent, 75 wt % of Li₄Ti₅O₁₂ and 15 wt % of hard carbon as hybrid anode active material, 5 wt % of (PVDF) as binder and 5 wt % of carbon black as conductive agent were added to form slurry for an anode electrode. The anode slurry was evenly coated on Cu foil as anode current collector and dried to form an anode electrode. Then, the anode electrode was subjected to roll process.

(Manufacture of Cathode Electrode)

To NMP as a solvent, 90 wt % of LiNi_{1/3}Co_{1/3}Mn_{1/3}O₂ as cathode active material, 5 wt % of PVDF as binder and 5 wt % of carbon black as conductive agent were added to form slurry for a cathode electrode. The cathode slurry was evenly coated on Al foil as cathode current collector and dried to form a cathode electrode. The cathode electrode then was subjected to roll process.

(Manufacture of Secondary Lithium Ion Battery)

The anode electrode and the cathode electrode obtained as described above were stacked with separator of microporous membrane of polypropylene (PP) interposed therebetween to form an assembly. Then, an electrolyte (propylene carbonate (PC)/ethylene carbonate (EC)/dimethyl carbonate (DMC)=1:1:1 (weight ratio) containing 1M of lithium hexafluorophosphate (LiPF₆)) was injected thereto to provide a secondary lithium ion battery.

### Example 2

To N-methyl-2-pyrrolidone (NMP) as a solvent, 75 wt % of Li₄Ti₅O₁₂ and 15 wt % of soft carbon as hybrid anode active material, 5 wt % of PVDF as binder and 5 wt % of carbon black as conductive agent were added to form slurry for an anode electrode. The anode slurry was evenly coated on Cu foil as anode current collector and dried to form an anode electrode. Then, the anode electrode was subjected to roll process.

(Manufacture of Cathode Electrode)

To NMP as a solvent, 90 wt % of LiNi_{1/3}Co_{1/3}Mn_{1/3}O₂ as cathode active material, 5 wt % of PVDF as binder and 5 wt % of carbon black as conductive agent were added to form slurry for a cathode electrode. The cathode slurry was evenly coated on Al foil as cathode current collector and dried to form a cathode electrode. Then, the cathode electrode was subjected to roll process.

(Manufacture of Secondary Lithium Ion Battery)

The anode electrode and the cathode electrode obtained as described above were stacked with separator of microporous membrane of polypropylene (PP) interposed therebetween to form an assembly. Then, an electrolyte (propylene carbonate (PC)/ethylene carbonate (EC)/dimethyl carbonate (DMC)=1:1:1 (weight ratio) containing 1M of lithium hexafluorophosphate (LiPF₆)) was injected thereto to provide a secondary lithium ion battery.

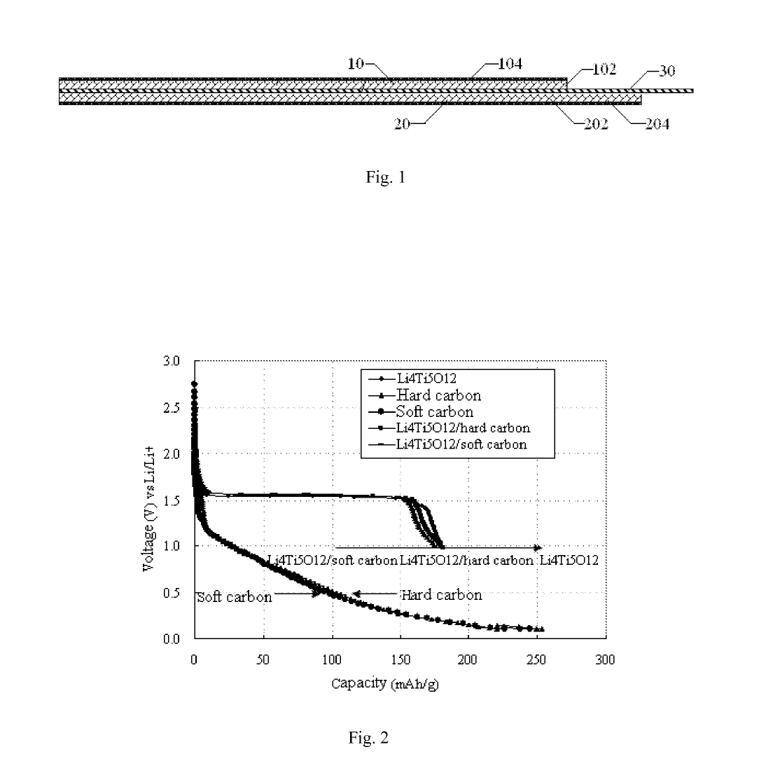

Anode electrodes of Comparative Example, Example 1 and Example 2, hard carbon anode electrode and soft carbon anode electrode were subjected to capacity test in coin cell test with lithium metal as counter electrode. First charge curves were shown in FIG. 1.

FIG. 1 shows that the plateau voltage of Li₄Ti₅O₁₂ relative to the lithium counter electrode is about 1.55V. Anode electrode which uses Li₄Ti₅O₁₂/hard carbon hybrid anode active material or Li₄Ti₅O₁₂/soft carbon hybrid anode active material can fully utilize lithium ion absorption/desorption capacity of hard carbon or soft carbon at a voltage above 1.0V. The hard carbon and the soft carbon have similar electrochemical property and, therefore, charge curves of the hard carbon anode electrode and the soft carbon anode electrode substantially coincide.

Anode electrodes of Comparative Example, Example 1 and Example 2 were subjected to electronic conductivity test and the test results were shown in FIG. 2.

FIG. 2 shows that, electronic conductivity of the anode electrode which uses Li₄Ti₅O₁₂/hard carbon hybrid anode active material or Li₄Ti₅O₁₂/soft carbon hybrid anode active material is better than the electronic conductivity of the anode electrode which only uses Li₄Ti₅O₁₂ as the anode active material. The anode electrode which uses Li₄Ti₅O₁₂/hard carbon hybrid anode active material almost has the same electronic conductivity as that of the anode electrode which uses Li₄Ti₅O₁₂/soft carbon hybrid anode active material.

According to the results of FIG. 1 and FIG. 2, the Li₄Ti₅O₁₂/hard carbon hybrid anode active material and the Li₄Ti₅O₁₂/soft carbon hybrid anode active material have almost the same electrochemical performance. Therefore, only the test results of Example 1 and Comparative Example are compared as below.

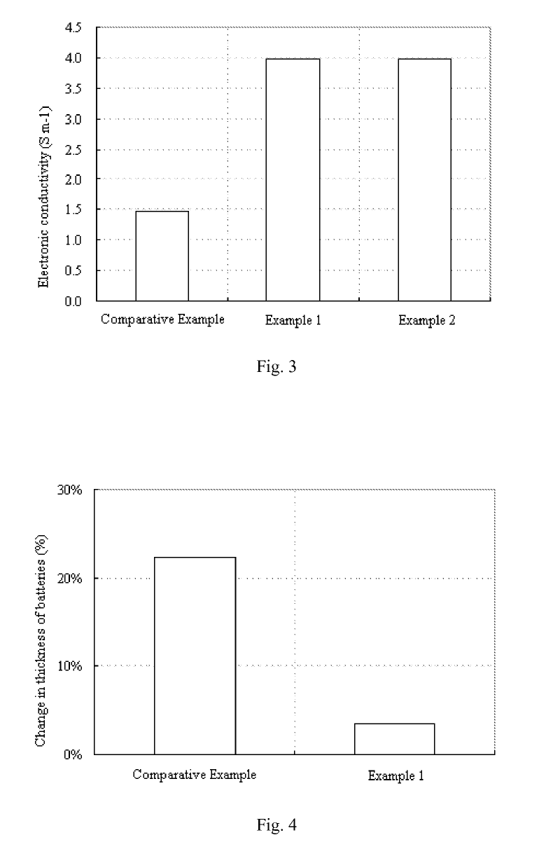

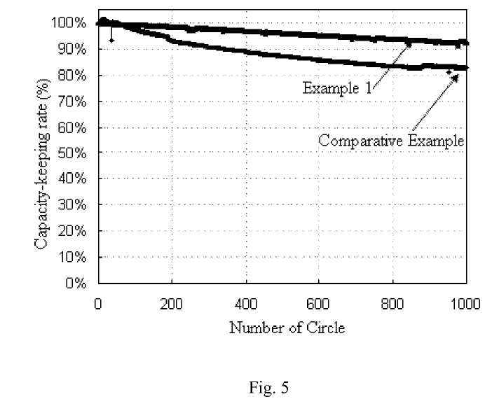

The secondary lithium ion batteries of Comparative Example and Example 1 were fully charged and then were stored at 85° C. for 4 hours. Changes in thickness of the secondary lithium ion batteries of Comparative example and example 1 before storage and after storage were recorded and shown in FIG. 3.

FIG. 3 shows that after stored at high temperature, volume change of the fully charged secondary lithium ion battery which uses Li₄Ti₅O₁₂/hard carbon hybrid anode active material is smaller than that of the fully charged secondary lithium ion battery which uses Li₄Ti₅O₁₂ anode active material, indicating that the Li₄Ti₅O₁₂/hard carbon hybrid anode active material can reduce cell swelling of the secondary lithium ion battery.

Secondary lithium ion batteries of Comparative Example 1 and Example 1 were circled at 45° C. at the rate of 10 C/10 C with the cyclic voltage ranging from 1.5V to 2.8V. The capacity loss results were shown in FIG. 4.

FIG. 4 shows that, after 1000 circles at 45° C., capacity of the secondary lithium ion battery which uses Li₄Ti₅O₁₂/hard carbon hybrid anode active material reduces to 92% of its initial capacity. Capacity of the secondary lithium ion battery which only uses Li₄Ti₅O₁₂ as anode active material reduces to 82% of its initial capacity. According to the test results, Li₄Ti₅O₁₂/hard carbon hybrid anode active material can remarkably improve cyclic performance of the secondary lithium ion battery, especially at high temperature.

While the present invention has been illustrated by the above description of the preferred embodiment thereof, while the preferred embodiment has been described in considerable detail, it is not intended to restrict or in any way limit the scope of the appended claims to such details. Additional advantages and modifications within the spirit and scope of the present invention will readily appear to those ordinary skilled in the art. Consequently, the present invention is not limited to the specific details and the illustrative examples as shown and described.

What is claimed is:

1. A secondary lithium ion battery, comprising:
an anode electrode comprising an anode current collector and an anode active material formed on the anode current collector;
a cathode electrode comprising a cathode current collector and a cathode active material formed on the cathode current collector;
a separator interposed between the anode electrode and the cathode electrode; and
a nonaqueous liquid electrolyte;
wherein the anode active material contains lithium titanate and amorphous carbon.

2. The secondary lithium ion battery of claim 1, wherein the anode active material contains lithium titanate and hard carbon, or contains lithium titanate and soft carbon, or contains lithium titanate, hard carbon and soft carbon.

3. The secondary lithium ion battery of claim 1, wherein the amorphous carbon has a shape of needle, tube flake, sphere or fiber.

4. The secondary lithium ion battery of claim 1, wherein the amorphous carbon has a size ranging from several nanometers to dozens of micrometers.

5. The secondary lithium ion battery of claim 1, wherein the amorphous carbon has a size ranging from several hundreds of nanometers to several micrometers.

6. The secondary lithium ion battery of claim 1, wherein weight ratio of the lithium titanate to the amorphous carbon ranges from 98:2 to 50:50.

7. The secondary lithium ion battery of claim 1, wherein the amorphous carbon has d₀₀₂ spacing larger than 0.34 nm.

8. The secondary lithium ion battery of claim 1, wherein the anode electrode contains binder and carbonaceous conductive agent formed thereon.

9. The secondary lithium ion battery of claim 8, wherein the carbonaceous conductive agent is selected from a group consisting of carbon black, vapor grown carbon fiber and graphite.
